(19) United States
(12) Patent Application Publication
(10) Pub. No.: US 2026/0339661 A1
(43) Pub. Date: Oct. 29, 2026

(54) EXECUTABLE CODE MIGRATION ACROSS COMPUTING ENVIRONMENTS

(71) Applicant: Honeywell International Inc., Charlotte, NC (US)

(72) Inventors: Shiju Sasidharan, Alleppey (IN); Girish Venkatasubbarao, Bangalore (IN); Bala Rama Chandran Tanjore, Hyderabad (IN); Pavithra K, Bangalore (IN); Shourya Shashank, Noida (IN); Ashwath Kakde Sunderkumar, Bangalore (IN)

(21) Appl. No.: 19/190,832

(22) Filed: Apr. 28, 2025

(51) Int. Cl. G06F 8/76; G06F 8/51

(52) U.S. Cl. CPC G06F 8/76; G06F 8/51

(57) ABSTRACT

Approaches for migrating an executable code corresponding to an industrial process from a first computing environment to a second computing environment are described. In an example, a first executable code which is configured to operate in the first computing environment is obtained. Once obtained, the first executable code is analyzed to determine a characteristic information. Based on the analysis of the first executable code and an identifier indicating information of one of a second code type (i.e., type of code used by second computing environment) or the second computing environment, specific migration requirements are identified. Thereafter, the second executable code is generated by converting the first executable code based on the identified migration requirements.

### BACKGROUND

Industrial processes, specifically in manufacturing sectors like oil and gas, refinery, petrochemicals, and mining, rely on calculations based on process data, operational functions, and specific parameters to ensure optimal performance, productivity, efficiency, and safety. These calculation functions, often managed by applications which runs in an on-premises computer. The process calculations are implemented in calculation applications using executable codes, which are used to determine factors such as feed, yield, production rates, equipment performance, and process optimizations. As businesses move towards digital transformation and cloud-based solutions, there is a growing need to migrate these on-premises legacy calculation applications to modern, cloud-based platforms in short span of time without impacting the functional operations and compromising on the calculation accuracy.

### BRIEF DESCRIPTION OF FIGURES

Systems and/or methods, in accordance with examples of the present subject matter are now described and with reference to the accompanying figures, in which:

FIG. 1 illustrates a computing system for migrating executable code between computing environments, as per an example;

FIG. 2 illustrates a communication environment comprising a migration system, as per an example;

FIG. 3 illustrates a computing system for training a migration model, as per an example;

FIG. 4 illustrates a detailed block diagram of a migration system, as per an example;

FIG. 5 illustrates a correlation mapping, as per an example;

FIG. 6 illustrates a method for migrating executable code between computing environments, as per an example;

FIG. 7 illustrates a method for training a migration model and migrating an executable code between computing environments, as per an example;

FIG. 8 illustrates another method for migrating executable code between computing environments, as per another example; and

FIG. 9 illustrates a system environment implementing a non-transitory computer readable medium for migrating executable code between computing environments, as per an example.

### DETAILED DESCRIPTION

Calculation and assessment applications (thereafter referred to as CAS applications) are tools in modern computing environments. These applications are designed to collect data across various systems running in the manufacturing plant or any other facility and process them to perform calculations automatically on schedule or on occurrence of event(s). Thereafter, based on the outcome of the calculation, further actions may be taken to run the process to achieve required efficiency and productivity. Such CAS applications typically consist of executable code that performs specific operations on input data to produce desired outputs. There are several types of CAS applications, including those designed for financial modelling, scientific simulations, industrial process control, and business intelligence. CAS Application may vary in complexity, from simple spreadsheet-like tools to software packages capable of handling algorithms and large datasets.

CAS applications find extensive use in industries such as manufacturing, finance, healthcare, and energy. CAS applications are used for tasks such as production planning, quality control, risk assessment, performance optimization, and many more. Specifically, in industrial settings, CAS applications are used to calculate and to monitor the key performance indicators and process metrics and enable adjustment to the processes in real-time, ensuring productivity, efficiency and safety. Earlier, many industries relied on on-premises implementations of CAS applications. Such localized/on-premises implementation of CAS applications is performed on a system which is installed and operated on the organization's own hardware and infrastructure. It may be noted that, while this approach offers direct and quick monitoring of the process conditions, it comes with several drawbacks. For example, on-premises implementations may be costly to maintain, difficult to scale, and may lack the flexibility to adapt to rapidly changing processing and business needs. Additionally, they may struggle with integrating new technologies or handling increasing data volumes.

To address these limitations, organizations considered migrating their CAS applications from legacy on-premises environment to a remote computing environment, such as cloud-based environment. Such migration may potentially offer benefits such as improved scalability, easier maintenance, and access to advanced features and integrations. To do the same, certain migration procedures are used which often involve engineering efforts in performing manual code conversion, where developers analyse the existing code of the calculation application and rewrite the code for the same calculations for the new environment. Such manual conversion process may also include data mapping, mapping the mathematical and logical functions and libraries from the old application environment to equivalent or similar components in the new application environment.

However, conventional migration approaches may face several challenges. For example, these migration methodologies may be time-consuming, error-prone, and require extensive expertise in both the legacy and new computing environments. The complexity of legacy CAS applications, with their specialized functions and intricate dependencies, may further complicate the migration process. Additionally, ensuring that the migrated application maintains the same level of accuracy and reliability as the original is desired, especially in industries where calculations directly impact operation of the critical processes or decision-making.

Approaches for migrating an executable code corresponding to an industrial process from a legacy environment to a cloud-based environment are described. In an example, as industrial CAS applications evolve and adapt to technological advancements, they often require migration between different computing environments, e.g., migrating from conventional on-premise environment to more scalable and flexible cloud-based environment.

For migrating executable code from one environment to another, a migration system is implemented. The migration system (referred to as system) is to determine to-be performed transformations based on analysis of characteristic information of a source executable code and based on a target environment's specifications. In an example, the system obtains a first executable code which is deployed and associated with an industrial process, and which is configured to operate in a first computing environment. The first executable code may be for implementing various industrial processes, such as calculations, assessment, data analysis, production analysis, and/or optimization analysis.

Thereafter, the system analyzes the first executable code to determine a characteristic information corresponding to the first executable code. In an example, the analysis of characteristic information involves examining plurality of characteristics of the first executable code including, but not limited to, a code structure, input variables, output variables, associated functions, and library used within the first executable code. Code structure, amongst other things, may refer to logical organization and arrangement of code elements to implement the intended function and/or operation. Continuing with the present example, the system may also identify input and output variables as defined in the first executable code, along with their associated data types, which are used for understanding the code's interaction with data. Furthermore, the system recognizes function definitions and their input/output parameters, as well as any library imports and external dependencies. It may be noted that, above mentioned characteristics are exemplary, and other characteristic may also be analyzed without deviating from the scope of the present subject matter.

Thereafter, migration of the first executable code is performed to a target or a second computing environment. In one example, the second computing environment may implement or utilize a code type that differs from the code type of the first executable code. Alternatively, the second computing environment may implement the same code type as the first computing environment, but with different capabilities or configurations. In both cases, the migration system adapts the first executable code to function effectively in the new computing environment.

Returning to the present example, based on the analysis of the first executable code and an identifier indicating information of one of a second code type (i.e., type of code used by second computing environment) or a second computing environment, the system identifies specific migration requirements. In an example, the identification of migration requirements may be based on a combination of predefined rules, pattern recognition, and contextual analysis. For example, the system compares the characteristics included within the characteristic information of the first executable code against known features and capabilities of the second computing environment, for determining the migration requirement.

In an example, the migration requirement is indicative of the transformations required to convert the first executable code into the second executable code which is compatible for the second computing environment. The migration requirement may be extensive and varied, potentially including programming language syntax adaptations, data type conversions, library and dependency updates, modifications to input/output mechanisms, adjustments to error handling and exception management, memory management optimizations, security protocol implementations, Application programming interface (API) and interface adaptations, and many other transformations depending on the specific needs of the second computing environment.

Continuing further, the system then proceeds to generate the second executable code by converting the first executable code based on the identified migration requirements. The conversion process involves a series of systematic transformations, including, but are not limited to, syntax restructuring, function mapping, and library substitutions. The system applies these transformations sequentially, often utilizing intermediate representations to manage changes. Such conversion process is designed to ensure that the resulting code is fully operational in the second computing environment, whether it's a different type of environment (e.g., transitioning from on-premises environment to cloud-based environment) or a different platform within the same environment itself. Throughout the conversion process, the system maintains the logical flow and functionality of the original code while adapting it to the constraints and capabilities of the target environment.

In another implementation, the system utilizes a machine learning model to identify the migration requirements. The machine learning model may be trained based on a comprehensive dataset comprising characteristics of various source codes, target code types, and their associated migration requirements. Further, the machine learning model may be trained based on certain context driven instructions and example prompts as well for guiding the conversion of the first executable code to the second executable code. By leveraging machine learning, the system may handle more complex and nuanced transformations.

Returning to the present example, once the second executable code is generated, to ensure the integrity and functionality of the converted code, the system performs a unit test on the second executable code. In an example, this test is performed to verify whether the functionality of the converted code, i.e., the second executable code, matches that of the original code, i.e., the first executable code. The unit test involves executing both the first and the second executable codes with identical input data and comparing their outputs. Based on comparison, if any discrepancies are detected in the outputs, the system generates alerts indicating the specific inconsistencies in the conversion process (e.g., specifically locating portions of the first executable code which are not converted appropriately), allowing for targeted troubleshooting and refinement.

In another example, the system is equipped to identify non-convertible portions of the first executable code based on a migration eligibility criterion. In an example, the migration eligibility criteria include code segments or code portions that may require special attention or manual intervention. By comparing the characteristics of the first executable code with the migration eligibility criteria, the system identifies one or more non-convertible code segments and subsequently displays the non-convertible code segments for review and manual conversion by skilled engineers, ensuring that all aspects of the code are properly addressed during the migration process.

It may be noted that, throughout the specification, “first executable code” and “source executable code” are used interchangeably. Similarly, “second executable code” and “target executable code” are also used interchangeably. Further, “first computing environment” and “source computing environment” are used interchangeably and “second computing environment” and “target computing environment” are used interchangeably.

The above-described approaches for migration of executable code are valuable across various industries and sectors where applications performing critical calculations or processes need to be transitioned between different computing environments. Above approaches allow for the seamless migration of code from legacy applications implemented on-premises platforms to modern cloud based platforms. By facilitating this migration, these approaches ensure continuity of operations, preservation of complex calculation logic, and the ability to leverage the advantages of advanced computing platforms. This migration process may be applied to a wide range of applications, from financial modelling and data analysis to scientific simulations and business intelligence tools. Ultimately, these approaches contribute to enhanced efficiency, scalability, and adaptability in diverse operational contexts, enabling organizations to modernize their computational infrastructure while maintaining the integrity of their critical processes.

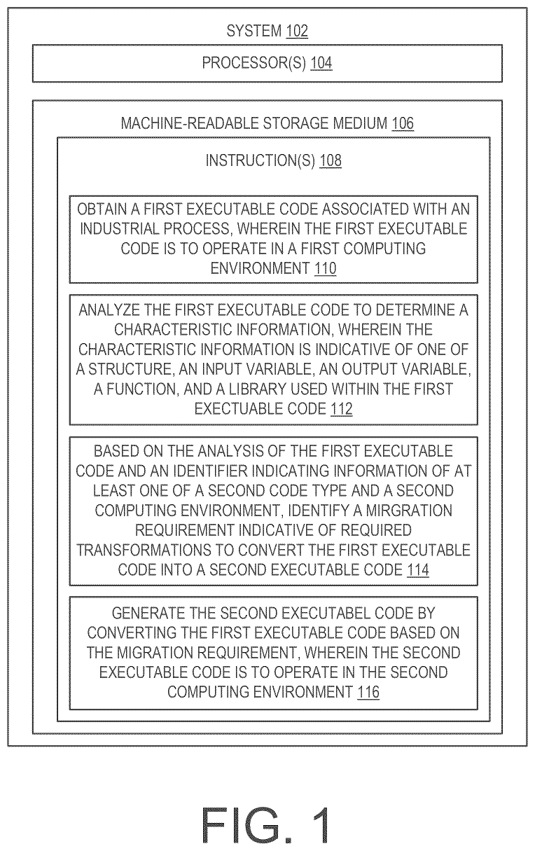

FIG. 1 illustrates an exemplary system 102 for migrating executable code corresponding to an industrial process between computing environments. The system 102 includes a processor 104, and a machine-readable storage medium 106 which is coupled to, and accessible by, the processor 104. The system 102 may be implemented in any computing system, such as an on-site industrial computer, a remote server, a distributed computing system, or the like. Although not depicted, the system 102 may include other components, such as interfaces to communicate over the network or with external storage or computing devices, display, input/output interfaces, operating systems, applications, data, and the like, which have not been described for brevity. This system 102 is designed to facilitate the seamless migration of executable codes between different computing environments, addressing the growing need for modernization and flexibility in industrial calculation applications.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to convert executable code between computing environments in industrial processes.

In an example, the processor 104 may fetch and execute instructions 108. As a result of the execution of the instructions 110, the system 102 may obtain a first executable code associated with an industrial process. In an example, the first executable code is corresponding to a calculation and assessment (CAS) application to perform a specified process and is obtained from a first computing environment. The first executable code is configured to operate in the first computing environment. In an example, the first executable code may utilize input data from various sources such as industrial control systems, process control software, or data management systems within the industrial environment to perform specified calculation and assessment. This step of obtaining first executable code involves interfacing with legacy calculation application and extracting code that may be associated with ongoing industrial operations or processes.

Once obtained, the instructions 112 may be executed to analyze the first executable code to determine a characteristic information. In an example, the characteristic information is indicative of at least one of a structure, an input variable, an output variable, a function, a library, or combination thereof used within the first executable code. The analysis may involve various code parsing techniques, static analysis methods, or machine learning algorithms to extract relevant characteristics from the executable code and include within the characteristic information. In an example, such characteristic information helps in understanding the code's functionality and dependencies, which is required for accurate conversion and maintaining the first executable code's intended behaviour or functionality in the new environment, i.e., a second computing environment.

Continuing further, the instructions 114 may then be executed to identify a migration requirement based on the analysis of the first executable code and an identifier indicating either a second code type or a second computing environment. In an example, the migration requirement is indicative of required transformations to convert the first executable code into a second executable code of the second code type. The identification of such migration requirement may be based on predefined conversion rules, correlation mappings, or machine learning model trained on executable code migration patterns. It may be noted that, the system 102 may also consider optimization opportunities during this phase, aiming not just for compatibility but also for improved performance in the second computing environment.

Finally, the instructions 116 may be executed to generate the second executable code by converting the first executable code based on the migration requirement. The second executable code is to operate in the second computing environment. In an example, the conversion process may involve syntax transformations, library replacements, API adaptations, or other necessary modifications to ensure compatibility with the second computing environment. In an example, the execution of instructions 116 may also include validation processes to ensure that the converted executable code maintains the integrity and functionality of the original first executable code, which is important in industrial settings where reliability and precision are paramount.

The above functionalities performed as a result of the execution of the instructions 108, may be performed by different programmable entities. Such programmable entities may be implemented through various computing systems, which may be implemented either on a single computing device, or multiple computing devices. As will be explained, various examples of the present subject matter are described in the context of a computing system for converting executable code between computing environments in industrial processes. These and other examples are further described with respect to other figures.

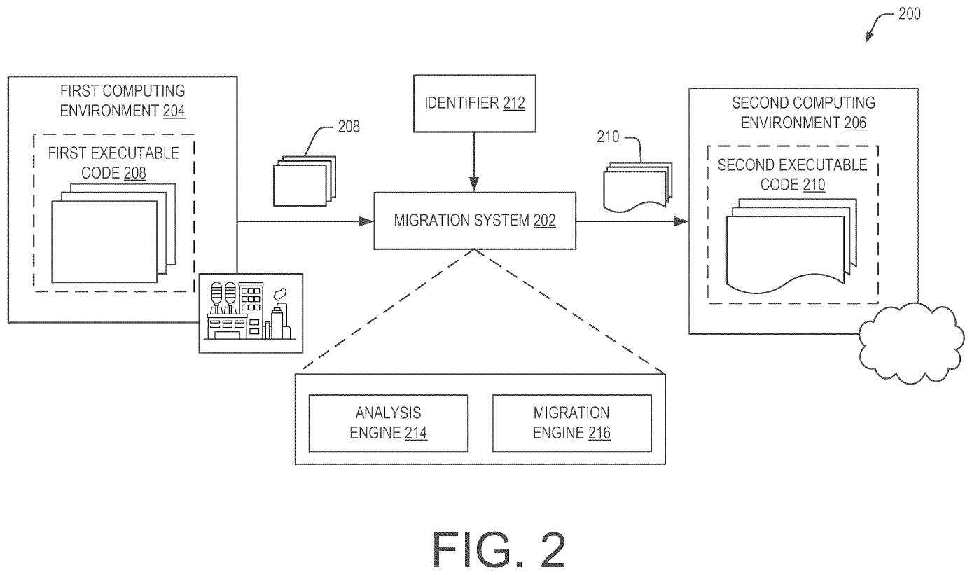

FIG. 2 illustrates a communication environment 200 comprising a migration system 202. The migration system 202 is used for converting a source executable code, which is compatible to be executed in a source computing environment, to a target executable code, which is compatible to be executed in a target computing environment. In an example, the conversion of source executable code to the target executable code is based on a migration requirement indicating necessary transformations, such as syntax modifications, library replacements, API adaptations, data type conversions, architectural changes, and many more to ensure compatibility and optimal performance of the target executable code in the target computing environment.

As depicted in FIG. 2, the communication environment 200 (referred to as environment 200) may include a first computing environment 204 (i.e., the source computing environment) and a second computing environment 206 (i.e., the target computing environment). In an example, the first computing environment 204 may be related to an industrial setting such as on-premise calculation application which works on the data obtained from, but are not limited to, manufacturing control systems, process automation platforms, or SCADA (Supervisory Control and Data Acquisition) systems. On the other hand, the second computing environment 206 may be related to a cloud-based platform setting.

It may be noted that, while FIG. 2 depicts the first computing environment 204 as an industrial setting and the second computing environment 206 as a cloud-based platform setting, this configuration is merely illustrative. The migration system 202 capability allows for various environmental combinations. For example, both environments may be industrial settings at different technological levels, or both may be cloud-based platforms with distinct architectures. Alternatively, the migration might occur between any two disparate computing paradigms.

Continuing further, the first computing environment 204 may include a first executable code 208 which is configured to be executed in the first computing environment 204. The first executable code 208 is to be converted into a second executable code 210 which is configured to be executed in the second computing environment 206. Examples of first and second executable code include, but are not limited to, code for statistical analysis of process variables, code for time series farecasting of production outputs, code for signal processing of sensor data, code for linear programming to optimize resource allocation, code related to cost-benefit analysis, code related to solving differential equations related to industrial process, and many more. It may be noted that, above-described examples of codes are exemplary, and it may include any other type of executable code catering to any specific industrial process in any industrial facility. The conversion of first executable code 208 into the second executable code 210 or migration of first executable code 208 to the second computing environment 206 is performed by the migration system 202.

In an example, the migration system 202 may further include an analysis engine 214 and a migration engine 216. The analysis engine 214 is responsible for parsing and analyzing the first executable code 208 to determine its characteristic information. On the other hand, the migration engine 216 utilizes the analysis results, i.e., the characteristic information, and an identifier 212 indicating information of one of a target code type or a target environment to determine a migration requirement. In an example, the identifier 212 may be provided by a user operating the migration system 202 to convert the first executable code 208 into the second executable code 210. Subsequently, the migration requirement indicating necessary transformations are applied onto the first executable code 208 to generate the second executable code 210 that is compatible with the second computing environment 206.

In operation, initially, the migration system 202 obtains the first executable code 208, which is the source code and is configured to operate in an initial environment, i.e., first computing environment 204. In an example, the first executable code 208 is obtained from a repository or storage system within the first computing environment 204. In an example, the first executable code 208 may be corresponding to a legacy industrial CAS application. Once obtained, the analysis engine 214 analyzes the first executable code 208 to determine a characteristic information. In an example, the characteristic information indicates, but may not be limited to, the structure, components (such as input/output variables), and dependencies of the code, providing a comprehensive overview of its architecture and functionality.

In an example, the analysis of first executable code 208 to determine the characteristic information involves various processing steps. For example, the analysis engine 214 parse the first executable code 208 to identify its structure, extract variable declarations and their data types, identify function definitions and their parameters, recognize library imports and external dependencies, and identify any custom data structures or classes.

Thereafter, based on the determined characteristic information and the identifier 212 indicating information of at least one of the second code type and the second computing environment 206, the migration engine 216 identifies the migration requirement. In an example, the migration requirement may indicate transformations, including programming language syntax adaptations, data type conversions, library and dependency updates, input/output mechanism changes, error handling modifications, memory management adjustments, security protocol implementations, and various other adaptations necessary for the code to function in the new environment, i.e., the second computing environment 206.

Examples of transformations include, but are not limited to, programming language syntax adaptations, data type conversions, library and dependency updates, scheduling changes (i.e., either periodic or event driven scheduling), input/output mechanism changes, error handling and exception management modifications, memory management adjustments, performance optimization techniques, security protocol implementations, API and interface adaptations, database query translations, file system access modifications, threading and concurrency model adjustments, logging and monitoring system integrations, user interface adaptations, network communication protocol updates, data serialization and deserialization method changes, configuration management adaptations, environment variable handling modifications, cloud service integrations, containerization requirements, scalability implementations, data storage mechanism changes, authentication and authorization system adaptations, versioning and deployment process modifications, domain-specific algorithm optimizations, or combination thereof. It may be noted that, the examples of transformations as stated above are exemplary and it may involve any other type of transformations as well without deviating from the scope of the present subject matter.

Once the migration requirement is identified, the migration engine 216 generates the second executable code 210 by converting the first executable code 208 based on the migration requirement. While identifying migration requirement, the migration system 202 is also capable of identifying non-convertible portions from the first executable code 208 based on a migration eligibility criteria. In an example, the migration eligibility criteria include details about code portions which are not convertible and require manual intervention. Based on the migration eligibility criteria, code segments or portions are identified which are non-convertible and flagged for review and manual conversion by an engineer, ensuring comprehensive handling of the code migration process.

Continuing further, once the first executable code 208 is converted into the second executable code 210, to ensure the accuracy of the conversion, the migration system 202 may perform a unit test on the second executable code 210. In an example, the unit test involves executing both the first executable code 208 and the second executable code 210 with identical input data and comparing their outputs. Based on the comparison, if any discrepancy is detected within the outputs, the migration system 202 generates an alert indicating the inconsistencies in the conversion process. In an example, the alert may also include details about the specific portions of code where the inconsistency occurred, the nature of the discrepancy, and suggestions for manual review or correction.

Once the conversion, review, manual conversion, and unit test process is completed, the second executable code 210 is transferred to the second computing environment 206 to be implemented within the second computing environment 206. The above-described processing steps ensure that the final code, i.e., the second executable code 210 is fully and accurately operational in its new setting, i.e., the second computing environment 206.

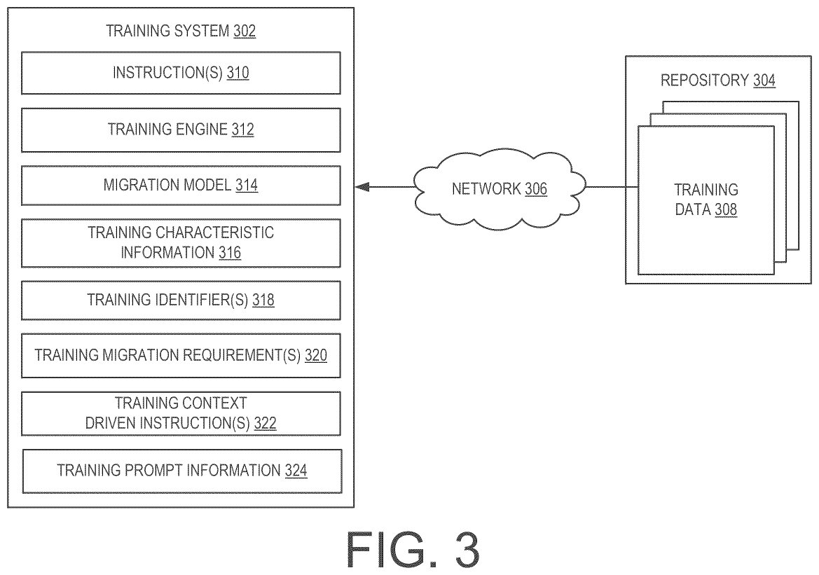

As described above as well, the identification of migration requirements may be performed using various techniques or approaches, such as using a trained machine learning model or using a correlation mapping. In an example, the machine learning model to identify the migration requirement for converting the first executable code, such as first executable code 208, to the second executable code, such as second executable code 210, may have to be trained and the same is further explained in conjunction with FIG. 3. FIG. 3 illustrates a training system 302 comprising a process or memory (not shown), for training a migration model to identify the migration requirement for converting the first executable code to the second executable code. In an example, the training system 302 may be communicatively coupled to a repository 304 through a network 306. The repository 304 may further include training data 308. The training data 308 may include training values corresponding to a plurality of characteristics included within the characteristic information of executable codes, training identifiers including information of at least one of a target code type and a target computing environment, and associated training migration requirements.

Examples of characteristics included within the characteristic information may include, but are not limited to, a structure, an input variable, an output variable, a function, and a library used within the executable code. The structure may indicate the logical organization and arrangement of code elements. Examples of some structures include, but are not limited to, sequential structures where code is executed in a linear fashion, iterative structures like loops for repetitive tasks, conditional structures such as if-else statements for decision-making, modular structures with functions or subroutines, object-oriented structures with classes and inheritance, and event-driven structures common in user interface programming or real-time systems.

Further, input variables may include variable declarations and their associated data types, while output variables may represent the data produced by the code. For example, input variables might include user-provided parameters like transaction amount (float), customer ID (string), or product quantity (integer), while output variables may be calculated results such as total cost (float), order status (string), or inventory level (integer). Furthermore, the functions may encompass function definitions and their input/output parameters. For example, a function like ‘calculate_discount(purchase_amount: float, customer_type: string)−>float’ defines a function that takes a float and a string as inputs and returns a float output. Libraries may include library imports and external dependencies utilized by the code. For example, this might include standard libraries like ‘math’ for mathematical operations, ‘datetime’ for date and time manipulations, or ‘requests’ for making HTTP requests. In more specialized applications, it may include domain-specific libraries such as ‘scipy’ for scientific computing, ‘pandas’ for data analysis, or ‘tensorflow’ for machine learning tasks.

Further, the training identifier may include information of at least one of a target code type and a target computing environment. The target code type may specify the desired programming language or framework for the converted code. For example, the target code type may be Python for its simplicity and extensive libraries, Java for its platform independence, or a domain-specific language like Structured Text for programmable logic controllers. While the target computing environment may indicate the platform or system where the converted code is intended to run. For example, the target computing environment may be a cloud-based platform for scalability and remote management, an edge computing device for low-latency processing, or a specific industrial hardware platform for direct integration with physical processes.

Furthermore, the training migration requirements may include training data corresponding to various transformations needed to convert code between different environments or languages. These transformations may include, but are not limited to, programming language syntax adaptations, data type conversions, library and dependency updates, input/output mechanism changes, error handling and exception management modifications, memory management adjustments, performance optimization techniques, security protocol implementations, API and interface adaptations, database query translations, file system access modifications, threading and concurrency model adjustments, logging and monitoring system integrations, user interface adaptations, network communication protocol updates, data serialization and deserialization method changes, configuration management adaptations, environment variable handling modifications, cloud service integrations, containerization requirements, scalability implementations, data storage mechanism changes, authentication and authorization system adaptations, versioning and deployment process modifications, and domain-specific algorithm optimizations.

In one example, the training data 308 may also include context driven instructions and example prompt information including plurality of prompts that may guide the model in making decisions for various migration scenarios. For example, the context driven instructions may include guidelines for handling specific programming paradigms, data type conversions, error handling practices, and performance optimization techniques. The prompts may include step-by-step instructions for converting specific code structures, such as “Convert this for-loop to a while-loop”, “Translate this object-oriented class to a functional programming approach”, or “Refactor this synchronous code to use asynchronous patterns”. Additionally, prompts may provide examples of how to handle language-specific features, like “Convert this Visual Basic (VB) pointer arithmetic to Python list operations” or “Translate this Java stream operation to equivalent JavaScript array methods”. These context-driven instructions and prompts may help the model understand the nuances of code migration across different languages and paradigms, enabling more accurate and efficient code transformations.

Further, the prompt information specify to the migration model what needs to be done for specific cases. For example, such prompts may provide a step-by-step process to convert one executable code to another if similar conditions are encountered. In some aspects, the prompt data may serve as a guide for the model, offering detailed instructions on how to approach particular scenarios or transformations. This may enable the model to learn from examples and apply similar strategies when faced with comparable situations during code conversion tasks. The inclusion of such prompt data in the training set may enhance the model's ability to handle diverse code conversion challenges and improve its overall performance in adapting executable code between different computing environments.

The training data 308 may also include examples of successful and unsuccessful migrations, complete with post-migration performance analyses, issues encountered, and lessons learned. This historical data helps the model understand the practical challenges and best practices in executable code migration. By incorporating this rich contextual information and prompt based guided decision-making examples, the training data 308 enables the migration model to make more informed and context-aware decisions when identifying migration requirements for complex calculation and assessment applications.

The training data 308, although depicted as being obtained from a single repository, such as repository 304, may also be obtained from multiple other sources without deviating from the scope of the present subject matter. In such cases, each of such multiple repositories may be interconnected through a network, such as the network 306.

The network 306 may be a private network or a public network and may be implemented as a wired network, a wireless network, or a combination of a wired and wireless network. The network 306 may also include a collection of individual networks, interconnected with each other and functioning as a single large network, such as the Internet. Examples of such individual networks include, but are not limited to, Global System for Mobile Communications (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone network (PSTN), Long Term Evolution (LTE) network, and Integrated Services Digital Network (ISDN).

The training system 302 may further include instructions 310 and a training engine 312. In an example, the instructions 310 are fetched from a memory and executed by a processor included within the training system 302. The training engine 312 may be implemented as a combination of hardware and programming, for example, programmable instructions to implement a variety of functionalities. In examples described herein, such combinations of hardware and programming may be implemented in several different ways. For example, the programming for the training engine 312 may be executable instructions, such as instructions 310. Such instructions may be stored on a non-transitory machine-readable storage medium which may be coupled either directly with the training system 302 or indirectly (for example, through networked means). In an example, the training engine 312 may include a processing resource, for example, either a single processor or a combination of multiple processors, to execute such instructions. In the present examples, the non-transitory machine-readable storage medium may store instructions, such as instructions 310, that when executed by the processing resource, implement the training engine 312. In other example, the training engine 312 may be implemented as electronic circuitry.

The instructions 310 when executed by the processing resource, cause the training engine 312 to train an artificial intelligence-based machine learning model, such as a migration model 314. In an example, the migration model 314, in context of FIG. 3 is trained based on training values corresponding to a plurality of characteristics included within the characteristic information of executable codes, training identifiers including information of at least one of a target code type and a target computing environment, and associated training migration requirements to identify a migration requirement based on characteristic information corresponding to a source executable code and a target code type identifier indicating the target code to which the source executable code is to be converted. The instructions 310 may be executed by the processing resource for training the migration model 314 based on the training data 308.

The training system 302 may further include training characteristic information 316 comprising values of various characteristics of the executable code and training identifier(s) 318 indicating information of at least one of the target code type to which the source executable code needs to be converted and a target computing environment, and corresponding training migration requirement(s) 320 indicating the transformations which are required in the source executable code to convert it into the target executable code. The training system 302 further include training context driven instruction(s) 322 and training prompt information 324.

In operation, the training system 302 may obtain the training data 308 from the repository 304 and data included in the training data 308 may be further stored as training characteristic information 316, training identifier(s) 318, training migration requirement(s) 320, training context driven instruction(s) 322 and training prompt information 324. In an example, the training characteristic information 316 include training information corresponding to various types of characteristics of the executable codes, such as code structure, input/output variables, functions, and libraries used. Further, the training identifier(s) 318 include identifiers indicating various types of codes which operate within any industrial settings related to any industrial process for different computing environment, such as on-premises systems, cloud-based platforms, or specific programming languages like Python, C++, or Java. Furthermore, the training migration requirement(s) 320 may include a comprehensive set of transformation rules, syntax adaptations, library replacements, and other necessary changes required to convert code from one environment to another.

Continuing further, once the training data 308 is obtained, the training engine 312 processes this data to train the migration model 314. In an example, the training process involves feeding the training characteristic information 316 and the corresponding training identifier(s) 318 into the migration model 314 as input, with the associated training migration requirement(s) 320 serving as the expected output. Based on this data, the migration model 314 learns to recognize patterns and relationships between the input features (characteristics and target code types or target computing environment) and the corresponding migration requirements.

In an example, while training, the migration model 314 may also consider guidance provided by the training context driven instruction(s) 322 and the training prompt information 324 to learn how to approach various code migration scenarios. The migration 314 model may use these instructions and prompts to understand the context of different programming paradigms, language-specific features, and best practices for code conversion. By incorporating this information, the migration model 314 may learn to make more informed decisions when translating code between different languages or environments, resulting in more accurate and efficient code migrations. Additionally, the model may learn to recognize patterns in the code that require specific migration approaches, allowing it to apply the appropriate conversion techniques based on the context provided by the instructions and prompts.

In an example, during the training process, the training engine 312 may employ various machine learning techniques such as supervised learning algorithms, including but not limited to decision trees, random forests, or neural networks, to train the migration model 314. These techniques enable the migration model 314 to learn mappings between code characteristics, target code or target environment, and the necessary migration steps. The training engine 312 may also use techniques like cross-validation to ensure the model's generalizability and prevent overfitting.

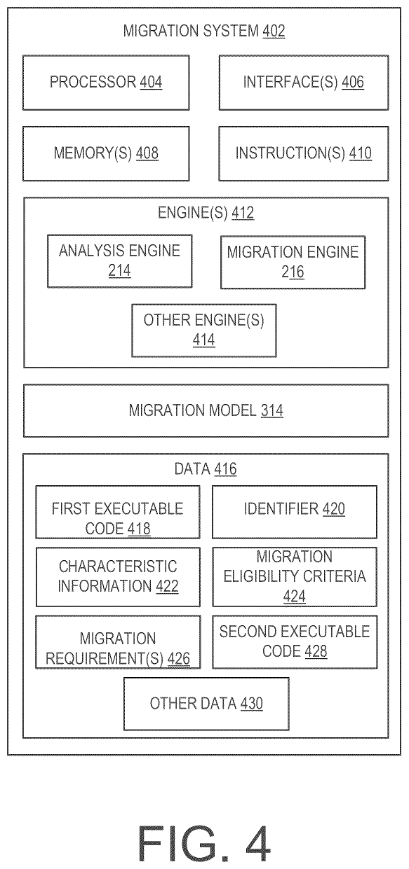

Once trained, the migration model 314 may be utilized for identifying migration requirements for new executable code based on its characteristics and the target code type or target computing environment. For example, when a new executable code, such as first executable code 208 is obtained by the migration system 202, the analysis engine 214 processes it to determine its characteristic information. This characteristic information, along with the identifier indicating the desired second code type or the second computing environment, is then input into the trained migration model 314. The migration model 314 analyzes this input and determines the necessary migration requirements for converting the first executable code 208 into the second executable code 210. These determined migration requirements may include specific transformations such as syntax changes, library replacements, or structural modifications needed to make the code compatible with the second computing environment. The migration engine 216 then uses these migration requirements to guide the actual conversion process, applying the necessary transformations to generate the second executable code 210. The specific manner in which the migration requirements are determined and applied by the trained migration model 314 is further described in conjunction with FIG. 4.

FIG. 4 illustrates a migration system 402 (similar to migration system 202) for converting a first executable code compatible with a first computing environment to a second executable code compatible with a second computing environment based on a migration requirement. In an example, the migration system 402 (referred to as system 402) may identify the migration requirement using one of the migration model 314, which is trained based on the training data 308, and a correlation mapping indicating mapping between the characteristic information, target code type or target computing environment and migration requirement for converting the first executable code into the second executable code.

The system 402 may include a processor 404, interface(s) 406 and memory 408. The processor 404 may be implemented as microprocessors, microcomputers, microcontrollers, digital signal processors, central processing units, state machines, logic circuitries, and/or other devices that manipulate signals based on operational instructions. Among other capabilities, the processor 404 may be configured to obtain a first executable code and then analyze the code to determine characteristic information. In an example, the processor 404 may also be capable of identifying migration requirement to convert the first executable code into the second executable code to make the code compatible to be implemented or executed within the second computing environment.

The interface(s) 406 may allow the connection or coupling of the system 402 with one or more computing devices or computing environments, such as first computing environment 204 and the second computing environment 206, through a wired network, a wireless network, or a combination of wired and wireless network. The interface(s) 406 may also enable intercommunication between different logical as well as hardware components of the system 402.

The memory 408 may be a computer-readable medium, examples of which include volatile memory (e.g., RAM), and/or non-volatile memory (e.g., Erasable Programmable read-only memory, i.e., EPROM, flash memory, etc.). The memory 408 may be an external memory, or internal memory, such as a flash drive, a compact disk drive, an external hard disk drive, or the like. The memory 408 may further include data which either may be utilized or generated during the operation of the system 402.

Similar to the system 102, the system 402 may further include instructions 410 and engine(s) 412. In an example, the instructions 410 are fetched from the memory 408 and executed by the processor 404 included within the system 402. The engine(s) 412 may include the analysis engine 214, the migration engine 216, and the other engine(s) 414 (as depicted in conjunction with FIG. 2). The other engine(s) 414 may further implement functionalities that supplement functions performed by the system 402 or any of the engine(s) 412. The analysis engine 214 and the migration engine 216 may be implemented as a combination of hardware and programming, for example, programmable instructions to implement a variety of functionalities. In examples described herein, such combinations of hardware and programming may be implemented in several different ways.

For example, the programming for the analysis engine 214 and the migration engine 216 may be executable instructions, such as instructions 410. Such instructions 410 may be stored on a non-transitory machine-readable storage medium which may be coupled either directly with the system 402 or indirectly (for example, through networked means). In an example, the analysis engine 214 and the migration engine 216 may include a processing resource, for example, either a single processor or a combination of multiple processors, to execute such instructions. In the present examples, the non-transitory machine-readable storage medium may store instructions, such as instructions 410, that when executed by the processing resource, implement the analysis engine 214 and the migration engine 216. In other examples, the analysis engine 214 and the migration engine 216 may be implemented as electronic circuitry.

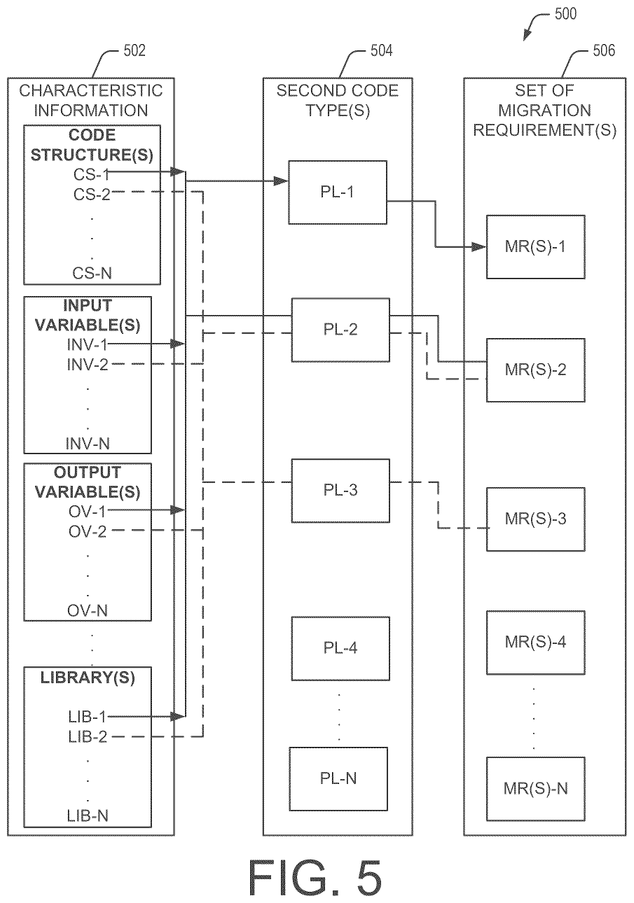

The system 402 may further include a trained migration model, such as migration model 314, a correlation mapping (not shown in FIG. 4), and a data 416. In an example, the correlation mapping indicates relationships between various characteristics of executable code, target code types or target computing environments, and corresponding migration requirements (the correlation mapping is described in detail in conjunction with FIG. 5 later in this description). The data 416 may include data that is utilized or generated by the system 402, while performing a variety of functions. In an example, the data 416 may include a first executable code 418, an identifier 420, a characteristic information 422, a migration eligibility criteria 424, a migration requirement(s) 426, a second executable code 428, and other data 430. In an example, the other data 430, amongst other things, may serve as a repository for storing data that is processed, or received, or generated as a result of the execution of the instructions by the processor 404.

In operation, initially, the system 402 may obtain the first executable code 418 from the first computing environment, such as first computing environment 204. In an example, the first executable code 418 may be corresponding to a legacy CAS application written in an older programming language. The first executable code 418 may include various components such as function definitions, variable declarations, control structures, and library dependencies specific to the first computing environment 204. The first executable code 418 may perform tasks such as data processing, numerical calculations, or control logic for industrial processes. The system 402 may obtain this code through various means, such as file transfer, or direct input from a user interface, preparing it for analysis and subsequent migration to the second computing environment 206.

Further, the system 402 may obtain the identifier 420 as well indicating one of a second code type or a second computing environment to which the first executable code 418 needs to be converted. In an example, the identifier 420 may specify the target environment (e.g., cloud-based platform), programming language (e.g., Python, Java, C++), or specific framework (e.g., .NET Core, Node.js) for the migration.

Thereafter, the analysis engine 214 of system 402 analyzes the first executable code 418 to determine characteristic information 422. The analysis of the first executable code 418 involves a comprehensive examination of the code's structure and components. Examples of characteristics included within the characteristic information 422 include, but are not limited to, a structure, an input variable, an output variable, a function, a library, and many more used within the first executable code 418.

In an example, to determine the characteristic information 422, the analysis engine 214 parses the first executable code 418 to identify its structure, which indicates the logical organization and arrangement of code elements. It further extracts variable declarations and their associated data types, identifying input and output variables crucial for the code's functionality. The analysis engine 214 also identifies function definitions and their input/output parameters, recognizing the core operations performed by the code. Further, library imports and external dependencies are also recognized, mapping out the code's reliance on external resources. Additionally, any custom data structures or classes defined in the first executable code 418 are identified as part of the structure.

It may be noted that, there may be certain portions in the first executable code 418 which are not convertible. In order to identify such portions, the migration engine 216 may analyze the determined characteristic information 422 with respect to the migration eligibility criteria 424 to identify non-convertible portions or code segments of the first executable code 418. Once identified, the analysis engine 214 displays the non-convertible code segments of the first executable code 418 onto a display device (not shown in FIG. 4) to be reviewed and manually converted by the engineer.

Continuing further, once the characteristic information 422 is determined, the migration engine 216 of the system 402 identifies migration requirement(s) 426 for converting the first executable code 418 into the second executable code 428. In an example, the migration requirement(s) 426 outlines or indicates the necessary transformations to convert the first executable code 418 into the second executable code 428.

In one example, the migration engine 216 may identify migration requirement(s) 426 based on a machine learning model, i.e., the migration model 314. The migration model 314, trained on a diverse dataset of code migrations, may identify the migration requirement(s) 426 indicating necessary transformations based on the input characteristics of the first executable code 418 and the identifier 420 of the second code type or the second computing environment. The migration model 314 is trained using training data that comprises training characteristic information of various executable codes, corresponding training identifiers, and their associated training migration requirements. Further, the migration model 314 may also be finetuned using context-based instructions and example prompts which guide the migration model 314 to take specific action in specific scenarios. When presented with the characteristic information 422 of the first executable code 418 and the identifier 420 of the desired second code type or second computing environment, the migration model 314 may identify the specific migration requirement(s) 426 needed for the conversion. These requirements may include various transformations such as syntax adaptations, library replacements, code restructuring, or data type conversions, tailored to the specific needs of migrating from the first executable code's environment to the target environment indicated by the second code type identifier.

Examples of transformations include, but are not limited to, programming language syntax adaptations, data type conversions, library and dependency updates, scheduling changes (i.e., either periodic or event driven scheduling), input/output mechanism changes, error handling and exception management modifications, memory management adjustments, performance optimization techniques, security protocol implementations, API and interface adaptations, database query translations, file system access modifications, threading and concurrency model adjustments, logging and monitoring system integrations, user interface adaptations, network communication protocol updates, data serialization and deserialization method changes, configuration management adaptations, environment variable handling modifications, cloud service integrations, containerization requirements, scalability implementations, data storage mechanism changes, authentication and authorization system adaptations, versioning and deployment process modifications, domain-specific algorithm optimizations, or combination thereof.

In another example, the migration engine 216 may obtain a correlation mapping to identify the migration requirement(s) 426. An exemplary representation of correlation mapping is depicted in FIG. 5. For example, FIG. 5 illustrates a correlation mapping 500 depicting a detailed view of the relationships between characteristic information of source code, potential target code types, and the resulting migration requirements. The correlation mapping 500 is divided into three main sections: characteristic information 502, second code type(s) 504, and set of migration requirement(s) 506. It may be noted that, although correlation mapping 500 depicts only second code type(s) 504 as intermediary section, however, identifier indicating the second computing environments may also be used without deviating from the scope of the present subject matter.

In an example, the characteristic information 502 represents the various aspects of the source code, i.e., the first executable code 418, that are analyzed during the migration process, subdivided into four key categories including, but are not limited to, code structure(s), input variable(s), output variable(s), library(s), and function(s). Each of these categories is labeled from 1 to N, indicating multiple instances or types within each category. For example, in the code structure(s) category, CS-1 might represent a monolithic structure where all code is in a single, large file, while CS-2 may indicate a modular structure with separate files for different functionalities. Some other examples of code structure(s) include, but are not limited to, object-oriented structures with classes and inheritance (CS-3), event-driven architectures common in real-time systems (CS-4), layered architectures separating concerns like data access, business logic, and presentation (CS-5), microservices architecture with distributed, independently deployable services (CS-6), pipeline structures for data processing workflows (CS-7), and state machine designs for systems with distinct operational states (CS-N).

Similarly, in the input variable(s) category, INV-1 might be a temperature sensor reading of type float, while INV-2 may be a pressure value of type double. The Output Variables and Libraries categories follow a similar pattern, representing the diverse range of outputs and dependencies in the first executable code 418.

Further, the Second Code Type(s) section in the middle of the diagram lists potential target programming languages or environments, including programming languages (PL-1), PL-2, PL-3, . . . , PL-N. Examples of second code type(s) include, but are not limited to, Python (PL-1) for its versatility and extensive libraries in data processing and machine learning, Java (PL-2) for its platform independence and robust enterprise-level applications, C (PL-3) for Windows-based and .NET environments, JavaScript (PL-4) for web-based and Node.js applications, Go (PL-5) for its efficiency in concurrent processing, Rust (PL-6) for systems programming with memory safety, R (PL-7) for statistical computing and graphics, MATLAB (PL-8) for numerical computing in engineering and scientific applications, Scala (PL-9) for its combination of object-oriented and functional programming paradigms, Swift (PL-10) for iOS and macOS development, Kotlin (PL-11) for Android development and server-side applications, Julia (PL-12) for high-performance numerical and scientific computing, and domain-specific languages like SQL (PL-13) for database operations or Ladder Logic (PL-14) for programmable logic controllers in industrial automation.

This section is connected to both the characteristic information 502 and set of migration requirement(s) 506, indicating its role as a bridge between the source code characteristics and the necessary migration steps. The set of migration requirement(s) section, labeled from MR(s)-1 to MR(s)-N, represents the various transformations and adaptations needed to convert the source code to the target environment. These requirements are directly linked to the Second Code Type(s), suggesting that different target code types or target environments may necessitate different migration strategies.

Exemplary migration requirement(s) include, but are not limited to, syntax adaptation for converting language-specific constructs, data type conversion for mapping between different type systems, library replacement for finding equivalent functions in the target environment, concurrency model adaptation for adjusting threading or asynchronous operations, memory management changes for transitioning between manual and automatic memory handling, error handling transformation for converting between different exception mechanisms, I/O operation conversion for adapting file or network operations, security implementation for updating authentication and encryption methods, API adaptation for interfacing with new system calls or services, database query translation for moving between different database systems, user interface redesign for adapting to new UI frameworks, performance optimization for leveraging target-specific features, containerization for enabling deployment in cloud environments, and domain-specific algorithm adaptation for optimizing critical operations in the new environment.

For example, consider an exemplary scenario where a code of an industrial control system is migrated from a legacy platform to a modern cloud-based environment using python as the programming language. In this example, characteristic information 422 of the first executable code 418 identified as below:

### Characteristic Information:

CS-1: The code has a modular structure with separate files for different control loops.
INV-1: One of the key input variables is a boolean representing a valve state.
OV-1: An important output variable is a float representing a calculated flow rate.
LIB-1: The code uses a proprietary library for PID (Proportional-Integral-Derivative) control.

### Second Code Type(s):

In this example, the second code type is Python as the target programming language.

### Migration Requirements:

Based on these characteristics and the second code type, the system 402 may identify the following migration requirements:
MR(s)-1: Convert the modular structure (CS-1) into Python modules and packages, adapt the boolean input (INV-1) to Python's built-in boolean type, ensure the float output (OV-1) is compatible with Python's float type, and replace the proprietary PID control library (LIB-1) with an equivalent Python library, such as simple-pid.

The correlation mapping 500 depicted in FIG. 5 not only correlates characteristic information 502 of source code and second code types 504 to migration requirement(s) 506, but may also include mappings for converting equipment identifiers and tag names from legacy systems to their corresponding representations in cloud applications. This additional mapping functionality enhances the system's 402 ability to maintain consistency and traceability during the migration process.

For instance, within the characteristic information 502 section, an additional category may be included to represent equipment and tag naming conventions. This category, may be labelled as ‘ID-1’ through ‘ID-N’, which include entries for various types of identifiers used in the legacy system.

In the migration requirement(s) 506 section, corresponding entries (e.g., MR(s)-4) may be added to specify the rules or transformations needed to convert these legacy identifiers to their cloud-based equivalents. For example:
ID-1 might represent a legacy equipment naming convention, with MR(s)-4 specifying how to translate it to a cloud-compatible format (e.g., ‘Reactor_01’ to ‘ChemicalReactor_Zone1_01’).
ID-2 may represent a legacy tag naming convention, with MR-16 defining the conversion to a more descriptive cloud-based naming scheme (e.g., ‘TT101’to ‘Temp_Reactor01_TopSection’).

This extended correlation mapping allows the migration system 402 to not only transform code structures and syntax but also to update all references to equipment, tags, and other named entities throughout the executable code. This comprehensive approach ensures that the migrated code is fully adapted to the naming conventions and organizational structure of the target cloud environment, facilitating seamless integration and improved maintainability of the migrated industrial control systems.

Returning to the present example, once the migration requirement(s) 426 are identified, the migration engine 216 generates the second executable code 428 by converting the first executable code 418 based on migration requirement(s) 426. This conversion process may involve a series of transformations, such as syntax changes, library replacements, code restructuring, and adaptation of data types and control structures to align with the second environment's specifications.

Below provided an example of a first executable code which is converted into a second executable code to be implemented on a second computing environment:

### First Executable Code:

‘PHDNODE=auawgp-phds01
’ *****************************************************************************

| | | |
|---|---|---|
| ‘ | LIBRARY NAME: | B46_Oxalate_hour |
| ’ | WORKGROUP NAME: | — |

| | | |
|---|---|---|
| ‘ | RESPONSIBLE ENGINEER: | Jamie Thomas |
| ’ | IT ENGINEER: | Jamie Thomas |

| | | |
|---|---|---|
| ‘ | FACILITIES: | — |

| | | |
|---|---|---|
| ’ | SCHEDULE FREQUENCY: | 1 hour |

| | | |
|---|---|---|
| ‘ | SCHEDULE TIME: | 7 minutes past the |

hour

| | | |
|---|---|---|
| ’ | BUSINESS IMPACT: | Medium |

| | | |
|---|---|---|
| ‘ | OBJECTIVE: | Lab data |

calculations

| | | |
|---|---|---|
| ’ | COMMONALITY: | — |

| | | |
|---|---|---|
| ‘ | EXTERNAL LIBRARIES : | PreApp Daily Average |

BCM calculations

| | | |
|---|---|---|
| ’ | EXTERNAL LIBRARIES : | PostApp No Post App |

requirements
************************************************************************************

| ‘ | Section: REVISION HISTORY | |
|---|---|---|
| ’ | Revision: Date: | Description: |

| | |
|---|---|
| Author: | Internal Approval: |

| | External Approval: | |
|---|---|---|
| ‘ | 00 27/11/19 | Original Code Library. |
| | | J Thomas |

’
************************************************************************************

| ‘ | Section: INPUTS | |
|---|---|---|
| ’ | Tagname | Type |

Description

************************************************************************************

| | |
|---|---|
| ‘ | Section: FACTORS |
| ’ | None |

‘
************************************************************************************

| | |
|---|---|
| ’ | Section: OUTPUTS |
| ‘ | Tagname |
| | Description |
| | Equation |

’
************************************************************************************

| | |
|---|---|
| ‘ | Section: BODY |

{initialise
’
************************************************************************************

| | |
|---|---|
| ‘ | STEP 1 DETECT NEW DATA AND CALL LIQUOR DENSITY |

CALCULATION
’
************************************************************************************
Dim dtHour As Date = zGetStartTime($CURTIME,“WA”,“H”)
Dim dtNow As Date = $CURTIME
Dim Oxalate As Double = fxTagVal(“OXL.OXALATE.47P”,dtNow)
Dim Hydrate As Double = fxTagVal(“OXL.HYDRATE.47P”,dtNow)
fxSendTagVal(“OXC.PCTTOT.OXSOLIDS”, Oxalate /(Oxalate + Hydrate *
10),dtHour)
fxSendTagVal(“OXC.PCTTOT.HYDSOLIDS”,1 − (Oxalate /(Oxalate +
Hydrate * 10)),dtHour)

### Second Executable Code:

```
pct_ox_solids = Oxalate / (Oxalate + Hydrate * 10)
pct_hyd_solids = 1 − pct_ox_solids
Value = {
  “OXC.PCTTOT.OXSOLIDS”: pct_ox_solids,
  “OXC.PCTTOT.HYDSOLIDS”: pct_hyd_solids
}
return Value
```

Once converted, the system 402 may also analyze the correctness of the generated code by performing a unit test. To perform the unit test, the system 402 executes both the first executable code 418 and second executable code 428 with identical input data to obtain a first output and a second output, respectively. The system 402 then compares the first output with the second output to ensure functional equivalence. If it is determined that the second output is inconsistent with the first output, the system 402 generates an alert indicating the discrepancy in the conversion process. In an example, the alert may include details about the specific portions of code where the inconsistency occurred, the nature of the discrepancy, and suggestions for manual review or correction.

Thereafter, once the second executable code 428 is generated and verified, the system 402 causes the second executable code to be transmitted and implemented within the second computing environment, such as the second computing environment 206. In an example, the implementation process may involve deploying the code to the second computing environment, configuring any necessary runtime environments, setting up required dependencies, and integrating the migrated code with existing systems in the new environment. In an example, the system 402 may also perform additional testing in the new environment, i.e., the second computing environment 206, to ensure proper functionality and performance under real-world conditions.

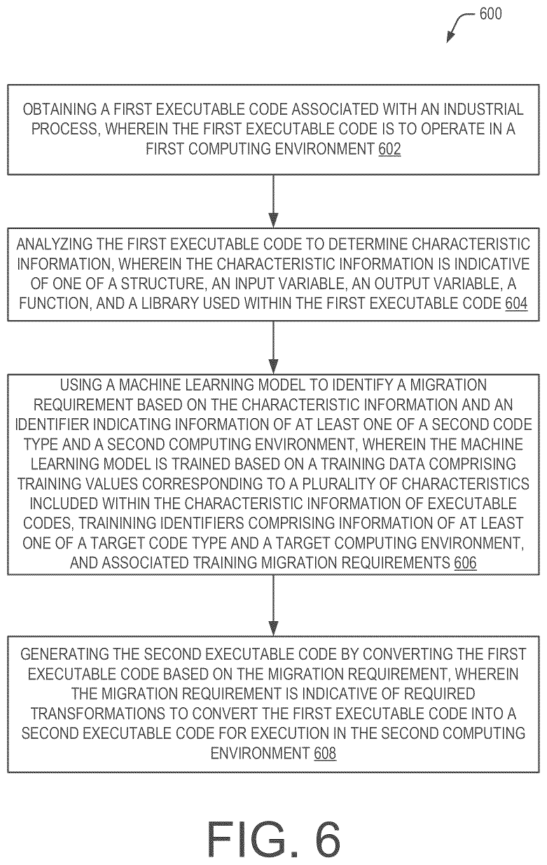

FIG. 6 illustrates example method 600 for migrating an executable code between computing environments, in accordance with examples of the present subject matter. The order in which the above-mentioned method is described is not intended to be construed as a limitation, and some of the described method blocks may be combined in a different order to implement the methods, or alternative methods.

Furthermore, the above-mentioned method 600 may be implemented in suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the method may be performed by a migration system, such as system 102, migration system 202, or migration system 402. In an implementation, the method may be performed under an “as a service” delivery model, where the migration system 102, 202, and 402, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 600 may be implemented by the system 402 for converting the first executable code 418 to the second executable code 428 based on the migration requirement(s) 426 determined using the trained migration model 314. At block 602, a first executable code which is associated with an industrial process is obtained. For example, the system 402 may obtain the first executable code 418 from the first computing environment, such as first computing environment 204. In an example, the first executable code 418 may be corresponding to a legacy CAS application written in an older programming language. The first executable code 418 may include various components such as function definitions, variable declarations, control structures, and library dependencies specific to the first computing environment 204. The first executable code 418 may perform tasks such as data processing, numerical calculations, or control logic for industrial processes. The system 402 may obtain this code through various means, such as file transfer, or direct input from a user interface, preparing it for analysis and subsequent migration to the second computing environment 206.

Further, the system 402 may obtain the identifier 420 as well indicating one of a second code type or a second computing environment to which the first executable code 418 needs to be converted. In an example, the identifier 420 may specify the target environment (e.g., cloud-based platform), programming language (e.g., Python, Java, C++), or specific framework (e.g., .NET Core, Node.js) for the migration.

At block 604, first executable code is analyzed to determine characteristic information. For example, the analysis engine 214 of system 402 analyzes the first executable code 418 to determine characteristic information 422. The analysis of the first executable code 418 involves a comprehensive examination of the code's structure and components. Examples of characteristics included within the characteristic information 422 include, but are not limited to, a structure, an input variable, an output variable, a function, a library, and many more used within the first executable code 418.

In an example, to determine the characteristic information 422, the analysis engine 214 parses the first executable code 418 to identify its structure, which indicates the logical organization and arrangement of code elements. It further extracts variable declarations and their associated data types, identifying input and output variables crucial for the code's functionality. The analysis engine 214 also identifies function definitions and their input/output parameters, recognizing the core operations performed by the code. Further, library imports and external dependencies are also recognized, mapping out the code's reliance on external resources. Additionally, any custom data structures or classes defined in the first executable code 418 are identified as part of the structure.

At block 606, a machine learning model is used to identify a migration requirement based on the characteristic information of the first executable code and an identifier indicating information of at least one of a second code type or a second computing environment. For example, once the characteristic information 422 is determined, the migration engine 216 of the system 402 identifies migration requirement(s) 426 for converting the first executable code 418 into the second executable code 428. In an example, the migration requirement(s) 426 outlines or indicates the necessary transformations to convert the first executable code 418 into the second executable code 428.

In one example, the migration engine 216 may identify migration requirement(s) 426 based on a machine learning model, i.e., the migration model 314. The migration model 314, trained on a diverse dataset of code migrations, may identify the migration requirement(s) 426 indicating necessary transformations based on the input characteristics of the first executable code 418 and the identifier 420 of the second code type or the second computing environment. The migration model 314 is trained using training data that comprises training characteristic information of various executable codes, corresponding training identifiers, and their associated training migration requirements. Further, the migration model 314 may also be finetuned using context-based instructions and example prompts which guide the migration model 314 to take specific action in specific scenarios. When presented with the characteristic information 422 of the first executable code 418 and the identifier 420 of the desired second code type or second computing environment, the migration model 314 may identify the specific migration requirement(s) 426 needed for the conversion. These requirements may include various transformations such as syntax adaptations, library replacements, code restructuring, or data type conversions, tailored to the specific needs of migrating from the first executable code's environment to the target environment indicated by the second code type identifier.

At block 608, the second executable code is generated by converting the first executable code based on the migration requirement. For example, once the migration requirement(s) 426 are identified, the migration engine 216 generates the second executable code 428 by converting the first executable code 418 based on migration requirement(s) 426. This conversion process may involve a series of transformations, such as syntax changes, library replacements, code restructuring, and adaptation of data types and control structures to align with the second environment's specifications.

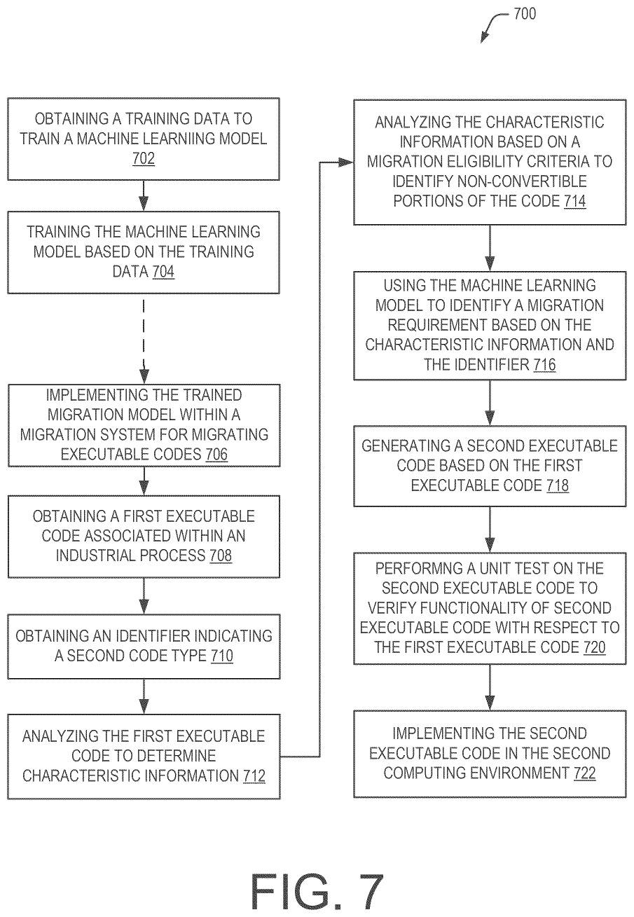

FIG. 7 illustrates example method 700 for training a migration model using which a migration requirement to convert the first executable code into the second executable code is determined. Based on the present approaches as described in the context of the example method, the first executable code is analyzed to determine characteristics information and subsequently using the characteristic information to identify the migration requirement for converting the first executable code into the second executable code. The present example method illustrates training of a migration model and migrating executable code between computing environments, based on such a trained estimation model. It is pertinent to note that such training and eventual migration of executable code may not occur in continuity and may be implemented separately without deviating from the scope of the present subject matter.

At block 702, a training data to train a machine learning model is obtained. For example, the training system 302 may obtain the training data 308 from the repository 304 and data included in the training data 308 may be further stored as training characteristic information 316, training identifier(s) 318, training migration requirement(s) 320, training context driven instruction(s) 322 and training prompt information 324. In an example, the training characteristic information 316 include training information corresponding to various types of characteristics of the executable codes, such as code structure, input/output variables, functions, and libraries used. Further, the training identifier(s) 318 include identifiers indicating various types of codes which operate within any industrial settings related to any industrial process for different computing environment, such as on-premises systems, cloud-based platforms, or specific programming languages like Python, C++, or Java. Furthermore, the training migration requirement(s) 320 may include a comprehensive set of transformation rules, syntax adaptations, library replacements, and other necessary changes required to convert code from one environment to another.

At block 704, the machine learning model is trained using the training data. For example, once the training data 308 is obtained, the training engine 312 processes this data to train the migration model 314. In an example, the training process involves feeding the training characteristic information 316 and the corresponding training identifier(s) 318 into the migration model 314 as input, with the associated training migration requirement(s) 320 serving as the expected output. Based on this data, the migration model 314 learns to recognize patterns and relationships between the input features (characteristics and target code types or target computing environment) and the corresponding migration requirements.

In an example, while training, the migration model 314 may also consider guidance provided by the training context driven instruction(s) 322 and the training prompt information 324 to learn how to approach various code migration scenarios. The migration 314 model may use these instructions and prompts to understand the context of different programming paradigms, language-specific features, and best practices for code conversion. By incorporating this information, the migration model 314 may learn to make more informed decisions when translating code between different languages or environments, resulting in more accurate and efficient code migrations. Additionally, the model may learn to recognize patterns in the code that require specific migration approaches, allowing it to apply the appropriate conversion techniques based on the context provided by the instructions and prompts.

At block 706, the trained migration model is implemented within a migration system for migrating an executable code across the computing environments. For example, once the migration model 314 is trained, it may be utilized for identifying migration requirement(s) for facilitating conversion of first executable code 418 into the second executable code 428. Although block 706 is depicted as following block 704, the migration model may be implemented separately without deviating from the scope of the present subject matter.

At block 708, a first executable code which is associated with an industrial process is obtained. For example, the system 402 may obtain the first executable code 418 from the first computing environment, such as first computing environment 204. In an example, the first executable code 418 may be corresponding to a legacy CAS application written in an older programming language. The first executable code 418 may include various components such as function definitions, variable declarations, control structures, and library dependencies specific to the first computing environment 204. The first executable code 418 may perform tasks such as data processing, numerical calculations, or control logic for industrial processes. The system 402 may obtain this code through various means, such as file transfer, or direct input from a user interface, preparing it for analysis and subsequent migration to the second computing environment 206.

At block 710, an identifier indicating one of a second code type or a second computing environment is obtained. For example, the system 402 may obtain the identifier 420 as well indicating one of a second code type or a second computing environment to which the first executable code 418 needs to be converted. In an example, the identifier 420 may specify the target environment (e.g., cloud-based platform), programming language (e.g., Python, Java, C++), or specific framework (e.g., .NET Core, Node.js) for the migration.

At block 712, the first executable code is analyzed to determine characteristic information. For example, the analysis engine 214 of system 402 analyzes the first executable code 418 to determine characteristic information 422. The analysis of the first executable code 418 involves a comprehensive examination of the code's structure and components. Examples of characteristics included within the characteristic information 422 include, but are not limited to, a structure, an input variable, an output variable, a function, a library, and many more used within the first executable code 418.

In an example, to determine the characteristic information 422, the analysis engine 214 parses the first executable code 418 to identify its structure, which indicates the logical organization and arrangement of code elements. It further extracts variable declarations and their associated data types, identifying input and output variables crucial for the code's functionality. The analysis engine 214 also identifies function definitions and their input/output parameters, recognizing the core operations performed by the code. Further, library imports and external dependencies are also recognized, mapping out the code's reliance on external resources. Additionally, any custom data structures or classes defined in the first executable code 418 are identified as part of the structure.

At block 714, the characteristic information is analyzed based on a migration eligibility criteria to identify a non-convertible portion of the code. For example, there may be certain portions in the first executable code 418 which are not convertible. In order to identify such portions, the migration engine 216 may analyze the determined characteristic information 422 with respect to the migration eligibility criteria 424 to identify non-convertible portions or code segments of the first executable code 418. Once identified, the analysis engine 214 displays the non-convertible code segments of the first executable code 418 onto a display device (not shown in FIG. 4) to be reviewed and manually converted by the engineer.

At block 716, a machine learning model is used to identify a migration requirement based on the characteristic information and the identifier. For example, once the characteristic information 422 is determined, the migration engine 216 of the system 402 identifies migration requirement(s) 426 for converting the first executable code 418 into the second executable code 428. In an example, the migration requirement(s) 426 outlines or indicates the necessary transformations to convert the first executable code 418 into the second executable code 428.

In one example, the migration engine 216 may identify migration requirement(s) 426 based on a machine learning model, i.e., the migration model 314. The migration model 314, trained on a diverse dataset of code migrations, may identify the migration requirement(s) 426 indicating necessary transformations based on the input characteristics of the first executable code 418 and the identifier 420 of the second code type or the second computing environment. The migration model 314 is trained using training data that comprises training characteristic information of various executable codes, corresponding training identifiers, and their associated training migration requirements. Further, the migration model 314 may also be finetuned using context-based instructions and example prompts which guide the migration model 314 to take specific action in specific scenarios. When presented with the characteristic information 422 of the first executable code 418 and the identifier 420 of the desired second code type or second computing environment, the migration model 314 may identify the specific migration requirement(s) 426 needed for the conversion. These requirements may include various transformations such as syntax adaptations, library replacements, code restructuring, or data type conversions, tailored to the specific needs of migrating from the first executable code's environment to the target environment indicated by the second code type identifier.

At block 718, a second executable code is generated by converting the first executable code based on the migration requirement. For example, once the migration requirement(s) 426 are identified, the migration engine 216 generates the second executable code 428 by converting the first executable code 418 based on migration requirement(s) 426. This conversion process may involve a series of transformations, such as syntax changes, library replacements, code restructuring, and adaptation of data types and control structures to align with the second environment's specifications.

At block 720, a unit test is performed on the second executable code to verity functionality of the second executable code with respect to the first executable code. For example, the system 402 may also analyze the correctness of the generated code by performing a unit test. To perform the unit test, the system 402 executes both the first executable code 418 and second executable code 428 with identical input data to obtain a first output and a second output, respectively. The system 402 then compares the first output with the second output to ensure functional equivalence. If it is determined that the second output is inconsistent with the first output, the system 402 generates an alert indicating the discrepancy in the conversion process. In an example, the alert may include details about the specific portions of code where the inconsistency occurred, the nature of the discrepancy, and suggestions for manual review or correction.

At block 722, the second executable code is implemented within the second computing environment. For example, once the second executable code 428 is generated and verified, the system 402 causes the second executable code to be transmitted and implemented within the second computing environment, such as the second computing environment 206. In an example, the implementation process may involve deploying the code to the second computing environment, configuring any necessary runtime environments, setting up required dependencies, and integrating the migrated code with existing systems in the new environment. In an example, the system 402 may also perform additional testing in the new environment, i.e., the second computing environment 206, to ensure proper functionality and performance under real-world conditions.

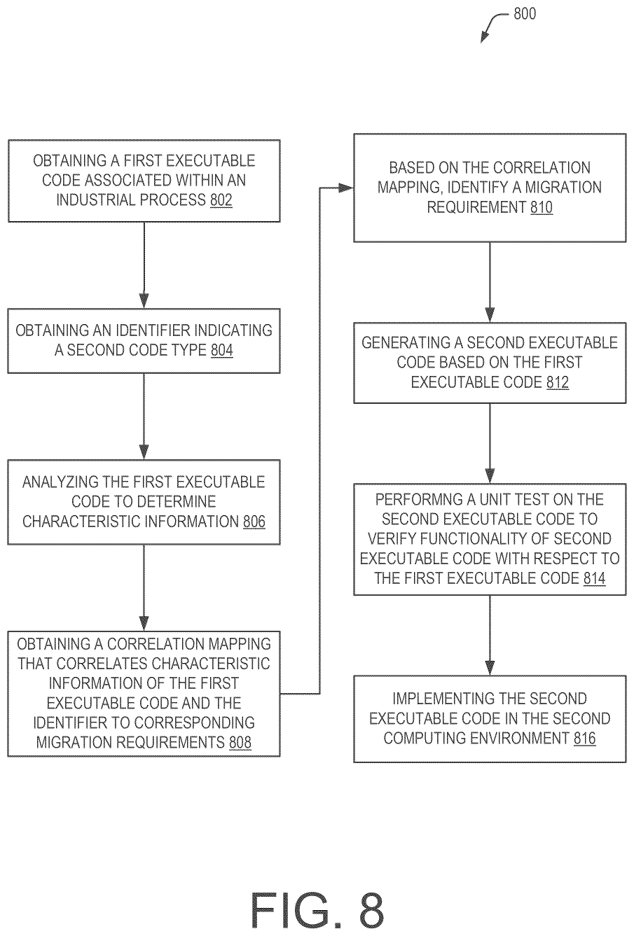

FIG. 8 illustrates example method 800 for migrating an executable code between computing environments, in accordance with examples of the present subject matter. The order in which the above-mentioned method is described is not intended to be construed as a limitation, and some of the described method blocks may be combined in a different order to implement the methods, or alternative methods.

Furthermore, the above-mentioned method 800 may be implemented in suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the method may be performed by a migration system, such as system 402. In an implementation, the method may be performed under an “as a service” delivery model, where the system 402, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 800 may be implemented by the system 402 for converting the first executable code 418 to the second executable code 428 based on the migration requirement(s) 426 determined using the correlation mapping 500. At block 802, a first executable code which is associated with an industrial process is obtained. For example, the system 402 may obtain the first executable code 418 from the first computing environment, such as first computing environment 204. In an example, the first executable code 418 may be corresponding to a legacy CAS application written in an older programming language. The first executable code 418 may include various components such as function definitions, variable declarations, control structures, and library dependencies specific to the first computing environment 204. The first executable code 418 may perform tasks such as data processing, numerical calculations, or control logic for industrial processes. The system 402 may obtain this code through various means, such as file transfer, or direct input from a user interface, preparing it for analysis and subsequent migration to the second computing environment 206.

At block 804, an identifier indicating one of a second code type or a second computing environment is obtained. For example, the system 402 may obtain the identifier 420 as well indicating one of a second code type or a second computing environment to which the first executable code 418 needs to be converted. In an example, the identifier 420 may specify the target environment (e.g., cloud-based platform), programming language (e.g., Python, Java, C++), or specific framework (e.g., .NET Core, Node.js) for the migration.

At block 806, the first executable code is analyzed to determine characteristic information. For example,
the analysis engine 214 of system 402 analyzes the first executable code 418 to determine characteristic information 422. The analysis of the first executable code 418 involves a comprehensive examination of the code's structure and components. Examples of characteristics included within the characteristic information 422 include, but are not limited to, a structure, an input variable, an output variable, a function, a library, and many more used within the first executable code 418.

In an example, to determine the characteristic information 422, the analysis engine 214 parses the first executable code 418 to identify its structure, which indicates the logical organization and arrangement of code elements. It further extracts variable declarations and their associated data types, identifying input and output variables crucial for the code's functionality. The analysis engine 214 also identifies function definitions and their input/output parameters, recognizing the core operations performed by the code. Further, library imports and external dependencies are also recognized, mapping out the code's reliance on external resources. Additionally, any custom data structures or classes defined in the first executable code 418 are identified as part of the structure.

At block 808, a correlation mapping that correlates characteristic information of the first executable code and the identifier to corresponding migration requirement is obtained. For example, the migration engine 216 may obtain a correlation mapping to identify the migration requirement(s) 426. An exemplary representation of correlation mapping is depicted in FIG. 5.

At block 810, based on the correlation mapping, a migration requirement is identified. For example, the system 402 may compare the characteristic information 422 of the first executable code 418 and the identifier 420 to the correlation mapping 500. This comparison may reveal specific migration requirements indicating transformations needed to convert the first executable code 418 into the second executable code 428. The migration requirement(s) 426 may include various aspects such as programming language syntax adaptations, data type conversions, library updates, or changes to input/output mechanisms. In some cases, the migration requirement may also encompass modifications to error handling, memory management optimizations, or security protocol implementations. In another example, the system 402 may identify multiple migration requirements depending on the code and the differences between the first and second computing environments.

At block 812, a second executable code is generated by converting the first executable code based on the migration requirement. For example, once the migration requirement(s) 426 are identified, the migration engine 216 generates the second executable code 428 by converting the first executable code 418 based on migration requirement(s) 426. This conversion process may involve a series of transformations, such as syntax changes, library replacements, code restructuring, and adaptation of data types and control structures to align with the second environment's specifications.

At block 814, a unit test is performed on the second executable code to verity functionality of the second executable code with respect to the first executable code. For example, the system 402 may also analyze the correctness of the generated code by performing a unit test. To perform the unit test, the system 402 executes both the first executable code 418 and second executable code 428 with identical input data to obtain a first output and a second output, respectively. The system 402 then compares the first output with the second output to ensure functional equivalence. If it is determined that the second output is inconsistent with the first output, the system 402 generates an alert indicating the discrepancy in the conversion process. In an example, the alert may include details about the specific portions of code where the inconsistency occurred, the nature of the discrepancy, and suggestions for manual review or correction.

At block 816, the second executable code is implemented within the second computing environment. For example, once the second executable code 428 is generated and verified, the system 402 causes the second executable code to be transmitted and implemented within the second computing environment, such as the second computing environment 206. In an example, the implementation process may involve deploying the code to the second computing environment, configuring any necessary runtime environments, setting up required dependencies, and integrating the migrated code with existing systems in the new environment. In an example, the system 402 may also perform additional testing in the new environment, i.e., the second computing environment 206, to ensure proper functionality and performance under real-world conditions.

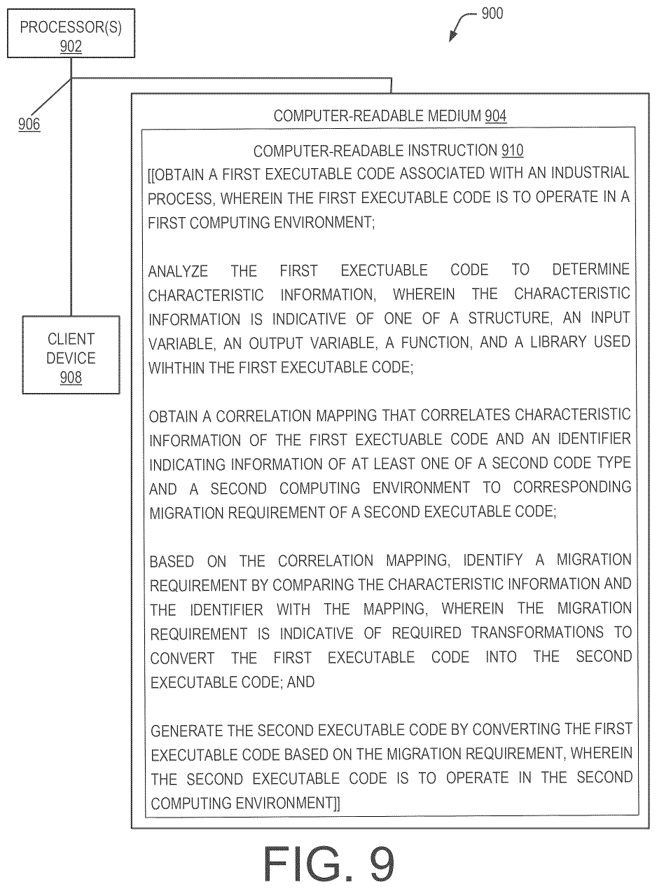

FIG. 9 illustrates a computing environment 900 implementing a non-transitory computer readable medium for migrating executable code between computing environments in industrial processes based on a migration requirement, wherein the migration requirement is identified to convert a first executable code into a second executable code. In an example, the computing environment 900 includes processor(s) 902 communicatively coupled to a non-transitory computer readable medium 904 through a communication link 906. In an example implementation, the computing environment 900 may be for example, the migration system 202, 402. In an example, the processor(s) 902 may have one or more processing resources for fetching and executing computer-readable instructions from the non-transitory computer readable medium 904. The processor(s) 902 and the non-transitory computer readable medium 904 may be implemented, for example, in migration system 202, 402 (as has been described in conjunction with the preceding figures).

The non-transitory computer readable medium 904 may be, for example, an internal memory device or an external memory device. In an example implementation, the communication link 906 may be a network communication link. The processor(s) 902 and the non-transitory computer readable medium 904 may also be communicatively coupled to a computing device 908 over the network.

In an example implementation, the non-transitory computer readable medium 904 includes a set of computer readable instructions 910 (referred to as instructions 910) which may be accessed by the processor(s) 902 through the communication link 906. Referring to FIG. 9, in an example, the non-transitory computer readable medium 904 includes instructions 910 that cause the processor(s) 902 to perform operations for migrating executable code between computing environments. The instructions 910 may be executed to obtain a first executable code, such as the first executable code 418 which is associated with an industrial process, where the first executable code 418 is configured to operate in a first computing environment, such as the first computing environment 204. In an example, the first executable code 418 may be a legacy code from an on-premises system or code designed for a specific industrial control platform.

Once the first executable code is obtained, the instructions 910 may cause the processor(s) 902 to analyze the first executable code 418 to determine characteristic information 422. In an example, the characteristic information 422 is indicative of one or more of a structure, an input variable, an output variable, a function, and a library used within the first executable code 418. Such analysis of the first executable code 418 provides a detailed understanding of the code's architecture and dependencies.

Thereafter, the instructions 910 may causes the processor(s) 902 to obtain a correlation mapping, such as correlation mapping 500 to determine the migration requirements for converting the first executable code 418 into a second executable code, such as second executable code 428. In an example, the correlation mapping 500 correlates characteristic information of the executable codes and an identifier indicating one of a second code type or a second computing environment to corresponding migration requirements, which should be used while converting the executable codes. In one example, the correlation mapping 500 serves as a reference guide for the code conversion process, linking features of the source code, i.e., first executable code 418 to corresponding migration requirements which needed to convert the first executable code 418 to the second executable code.

Based on this correlation mapping, the instructions 910 may cause the processor(s) 902 to identify the migration requirement. In an example, identification of migration requirement is performed by comparing the characteristic information of the first executable code and the identifier with the mapping to identify the relevant migration requirement. In one example, the migration requirement is indicative of required transformations to convert the first executable code 418 into the second executable code 428 for execution in the second computing environment 206.

Examples of transformations include, but are not limited to, programming language syntax adaptations, data type conversions, library and dependency updates, scheduling changes (i.e., either periodic or event driven scheduling), input/output mechanism changes, error handling and exception management modifications, memory management adjustments, performance optimization techniques, security protocol implementations, API and interface adaptations, database query translations, file system access modifications, threading and concurrency model adjustments, logging and monitoring system integrations, user interface adaptations, network communication protocol updates, data serialization and deserialization method changes, configuration management adaptations, environment variable handling modifications, cloud service integrations, containerization requirements, scalability implementations, data storage mechanism changes, authentication and authorization system adaptations, versioning and deployment process modifications, domain-specific algorithm optimizations, or combination thereof

Finally, the instructions 910 directs the processor(s) 902 to generate the second executable code 428 by converting the first executable code 418 based on the migration requirement(s) 426. In an example, the conversion process applies the identified transformations to create code that is compatible with and optimized for the second computing environment. The resulting second executable code 428 is designed to operate effectively in the second computing environment, maintaining the functionality of the original code while leveraging the features and capabilities of the target platform.

Throughout this process, the instructions 910 may cause the processor(s) 902 to perform additional steps such as identifying non-convertible portions of code, conducting unit tests to verify the converted code's functionality, and implementing the converted code in the second computing environment. In one example, the instructions 910 may cause the processor(s) 902 to generate a report detailing the conversion process, highlighting any issues encountered, and providing recommendations for manual intervention where necessary.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a machine-readable storage medium comprising instructions executable by the processor to:
obtain a first executable code associated with an industrial process, wherein the first executable code is to operate in a first computing environment;
analyze the first executable code to determine a characteristic information, wherein the characteristic information is indicative of one of a structure, input variables, output variables, associated functions, and a library used within the first executable code;
based on the characteristic information and an identifier indicating information of one of a second code type and a second computing environment, identify a migration requirement indicative of required transformations to convert the first executable code into a second executable code; and
generate the second executable code by converting the first executable code based on the migration requirement, wherein the second executable code is to operate in the second computing environment.

2. The system as claimed in claim 1, wherein to analyze the first executable code to determine a characteristic information, the instructions executable by the processor to:
parse the first executable code to identify the structure of the first executable code, wherein the structure of the first executable code indicates a logical organization and an arrangement of code elements within the first executable code;
extract variable declarations and their associated data types as input and output variables;
identify function definitions and their input/output parameters as function used within the first executable code;
recognize library imports and external dependencies as libraries used within the first executable code; and
identify a custom data structure or class defined in the first executable code as part of the structure.

3. The system of claim 1, wherein to identify a migration requirement, the instructions executable by the processor to:
compare the characteristic information of the first executable code with known features and capabilities of the second computing environment; and
based on the comparison, determine the migration requirement indicative of transformations to one of the structure, the input variable, the output variable, the function, and the library used within the first executable code.

4. The system as claimed in claim 1, wherein the transformations indicated by the migration requirement comprises one of programming language syntax adaptations, data type conversions, library and dependency updates, scheduling changes (i.e., either periodic or event driven scheduling), input/output mechanism changes, error handling and exception management modifications, memory management adjustments, performance optimization techniques, security protocol implementations, API and interface adaptations, database query translations, file system access modifications, threading and concurrency model adjustments, logging and monitoring system integrations, user interface adaptations, network communication protocol updates, data serialization and deserialization method changes, configuration management adaptations, environment variable handling modifications, cloud service integrations, containerization requirements, scalability implementations, data storage mechanism changes, authentication and authorization system adaptations, versioning and deployment process modifications, domain-specific algorithm optimizations, or combination thereof.

5. The system of claim 1, wherein the instructions are further executable by processor to:
perform a unit test on the second executable code to verify whether a functionality of the second executable code matches that of the first executable code, wherein to perform the unit test, the instructions are further executable by the processor to:
execute the first executable code and second executable code with identical input data to obtain a first output and a second output, respectively;
compare the first output with the second output; and
on determining the second output to be inconsistent with that of the first output, generate an alert indicating a discrepancy in conversion of first executable code into the second executable code.

6. The system of claim 1, wherein the instructions are further executable by the processor to:
identify a non-convertible code segment of the first executable code based on a migration eligibility criteria; and
display the non-convertible code segment on a display device for review and guide manual conversion by an engineer.

7. The system of claim 1, wherein the first computing environment and the second computing environment is one of an on-premises system and a cloud-based system, and the industrial process is associated with a process manager along with an industrial control system.

8. The system of claim 1, wherein the instructions are further executable by the processor to:
cause to implement the second executable code within the second computing environment.

9. A method comprising:
obtaining a first executable code associated with an industrial process, wherein the first executable code is to operate in a first computing environment;
analyzing the first executable code to determine characteristic information, wherein the characteristic information is indicative of one of a structure, an input variable, an output variable, a function, and a library used within the first executable code;
using a machine learning model to identify a migration requirement based on the characteristic information and an identifier indicating information of at least one of a second code type and a second computing environment, wherein the machine learning model is trained based on a training data comprising training values corresponding to a plurality of characteristics included within the characteristic information of executable codes, training identifiers comprising information of at least one of a target code type and a target computing environment, and associated training migration requirements; and
generating a second executable code by converting the first executable code based on the migration requirement, wherein migration requirement is indicative of required transformations to convert the first executable code into a second executable code for execution in the second computing environment.

10. The method of claim 9, wherein the transformations indicated by the migration requirement comprises one of programming language syntax adaptations, data type conversions, library and dependency updates, scheduling changes (i.e., either periodic or event driven scheduling), input/output mechanism changes, error handling and exception management modifications, memory management adjustments, performance optimization techniques, security protocol implementations, API and interface adaptations, database query translations, file system access modifications, threading and concurrency model adjustments, logging and monitoring system integrations, user interface adaptations, network communication protocol updates, data serialization and deserialization method changes, configuration management adaptations, environment variable handling modifications, cloud service integrations, containerization requirements, scalability implementations, data storage mechanism changes, authentication and authorization system adaptations, versioning and deployment process modifications, domain-specific algorithm optimizations, or combination thereof.

11. The method of claim 9, wherein to analyze the first executable code to determine the characteristic information, the method further comprises:
parsing the first executable code to identify the structure of the first executable code, wherein the structure of the first executable code indicates a logical organization and an arrangement of code elements within the first executable code;
extracting variable declarations and their associated data types as input and output variables;
identifying function definitions and their input/output parameters as functions used within the first executable code;
recognizing library imports and external dependencies as libraries used within the first executable code; and
identifying a custom data structure or class defined in the first executable code as part of the structure.

12. The method of claim 9, wherein the method further comprises:
identifying a non-convertible code segment of the first executable code based on a migration eligibility criteria, wherein the migration eligibility criteria indicates characteristics corresponding to the code segments which are non-convertible; and
displaying the non-convertible code segment on a display device for review and guide manual conversion by an engineer.

13. The method of claim 9, wherein the method further comprises:
performing a unit test on the second executable code to verify whether a functionality of the second executable code matches that of the first executable code, wherein to perform the unit test, the method comprises:
executing the first executable code and the second executable code with identical input data set to obtain a first output and a second output, respectively;
comparing the first output with the second output; and
on determining the second output to be inconsistent with that of the first output, generating an alert indicating a discrepancy in conversion of first executable code into the second executable code.

14. The method of claim 9, wherein the first computing environment and the second computing environment is one of an on-premises system and a cloud-based system.

15. The method of claim 9, wherein the industrial process is associated with a process manager in an industrial control system.

16. The method of claim 9, wherein the method comprises:
implement the second executable code within the second computing environment.

17. A non-transitory computer-readable medium comprising instructions, the instructions being executable by a processing resource to:
obtain a first executable code associated with an industrial process, wherein the first executable code is to operate in a first computing environment;
analyze the first executable code to determine a characteristic information, wherein the characteristic information is indicative of one of a structure, an input variable, an output variable, a function, and a library used within the first executable code;
obtain a correlation mapping that correlates characteristic information of the first executable code and an identifier indicating information of at least one of a second code type and a second computing environment to corresponding migration requirements of a second executable code;
based on the correlation mapping, identify a migration requirement by comparing the characteristic information and the identifier to the correlation mapping, wherein the migration requirement is indicative of required transformations to convert the first executable code into the second executable code; and
generate the second executable code by converting the first executable code based on the migration requirement, wherein the second executable code is to operate in the second computing environment.

18. The non-transitory computer-readable medium of claim 17, wherein the transformations indicated by the migration requirement comprises one of programming language syntax adaptations, data type conversions, library and dependency updates, scheduling changes (i.e., either periodic or event driven scheduling), input/output mechanism changes, error handling and exception management modifications, memory management adjustments, performance optimization techniques, security protocol implementations, API and interface adaptations, database query translations, file system access modifications, threading and concurrency model adjustments, logging and monitoring system integrations, user interface adaptations, network communication protocol updates, data serialization and deserialization method changes, configuration management adaptations, environment variable handling modifications, cloud service integrations, containerization requirements, scalability implementations, data storage mechanism changes, authentication and authorization system adaptations, versioning and deployment process modifications, domain-specific algorithm optimizations, or combination thereof.

19. The non-transitory computer-readable medium of claim 17, wherein the instructions being executable by the processing resource is to:
perform a unit test on the second executable code to verify whether a functionality of the second executable code matches that of the first executable code, wherein to perform the unit test, the instructions are further executable to:
execute the first executable code and the second executable code with identical input data to obtain a first output and a second output, respectively;
compare the first output with the second output; and
on determining the second output to be inconsistent with that of the first output, generate an alert indicating the discrepancy in conversion of first executable code into the second executable code.

20. The non-transitory computer-readable medium of claim 17, wherein the first computing environment and the second computing environment is one of an on-premises system and a cloud-based system, and the industrial process is associated with a process manager in an industrial control system.
